(19) United States
(12) Patent Application Publication
(10) Pub. No.: US 2023/0281542 A1
(43) Pub. Date: Sep. 7, 2023

(54) SYSTEM AND METHOD OF PROVIDING AN INTEGRATED DIGITAL ECOSYSTEM FOR ORGANIZATION MANAGEMENT

(71) Applicant: PEOPLELINK UNIFIED COMMUNICATIONS PRIVATE LIMITED, HYDERABAD (IN)

(72) Inventor: AMIT CHOWDRY, TELLAPUR (IN)

(21) Appl. No.: 18/004,084

(22) PCT Filed: Jul. 2, 2021
(86) PCT No.: PCT/IB2021/055962

§ 371 Date: Jan. 3, 2023

(30) Foreign Application Priority Data
Jul. 3, 2020 (IN) 202041028446

(51) Int. Cl. G06Q 10/0637; G06Q 10/10

(52) U.S. Cl. CPC G06Q 10/0637; G06Q 10/103

(57) ABSTRACT

A system and a method of providing an integrated digital ecosystem for an organization is disclosed. The system includes an organizational network management subsystem to establish integrated communication network for managing multiple stakeholders of an organization and provides a stakeholder workflow access corresponding to a level of permission for each of the multiple stakeholders. An organizational content management subsystem to provide an access of multiple organizational contents to each of the multiple stakeholders. An organizational activity analysis subsystem to track multiple activities performed by each of the multiple stakeholders corresponding to multiple tasks allocated and prioritized for each of the multiple stakeholders, analyzes the multiple activities to provide one or more insights related to development of the organization. An organizational process collaboration subsystem to provide one or more organization related services to each of the multiple stakeholders based on integration of an existing external platform using an application programming interface.

### EARLIEST PRIORITY DATE

This application claims priority from a Complete patent application filed in India having Patent Application No. 202041028446, filed on Jul. 3, 2020 and titled “SYSTEM AND METHOD OF PROVIDING AN INTEGRATED DIGITAL ECOSYSTEM FOR ORGANIZATION MANAGEMENT”.

### BACKGROUND

Embodiments of the present disclosure relate to an organization management system and more particularly to, a system and a method of providing an integrated digital ecosystem for organization management.

Digital transformation has been at the forefront of many organizations' strategies in recent years. But even for the organizations that have started their digital journeys, the next stage is to establish a digital ecosystem, which helps them to interact with those outside the company and improve performance. The digital ecosystem is an interdependent group of enterprises, people, and/or things that share standardized digital platforms for a mutually beneficial purpose, such as commercial gain, innovation, or a common interest. The digital ecosystem enables the organization to interact with customers, partners, adjacent industries and even one or more competitors. Also, the digital ecosystem allows an organization to focus its energies on facilitating business value by removing any frustrations linked to outdated, legacy business to business (B2B) services, adds value to customer relationships by helping the organizations to consistently meet service-level agreements, provide fast fixes and quickly surface expectations. Generally, creation of the digital ecosystem for any of the organizations is possible when the organization focuses on reworking the products, processes and strengths within the organization by using their current technologies. Various systems are available which provides an integrated platform to digitally transform the organization for the organization management.

Conventionally, the system available for the digital transformation of the organization involves partial digitization for the organizations, especially in small and mid-size business (SMB) sector. However, such a conventional system is unable to provide complete digitization of the organization because of the cost associated with it and also because of the non-availability of a single integrated platform to connect and offer one or more key stakeholders associated with the organization into the single integrated platform. Moreover, such a conventional system is unable to provide a single application for the one or more key stakeholders associated with the organization to work cohesively with one another and to personally connect with one another to digitally socialize.

Hence, there is a need for an improved system and a method of providing an integrated digital ecosystem for organization management in order to address the aforementioned issues.

### BRIEF DESCRIPTION

In accordance with an embodiment of the present disclosure, a system of providing an integrated digital ecosystem for organization management is disclosed. The system includes one or more processors hosted on a server. The system also includes an organizational network management subsystem to establish an integrated communication network for managing multiple stakeholders of an organization. The organizational network management subsystem also provides a stakeholder workflow access corresponding to a level of permission for each of the multiple stakeholders based on the integrated communication network established. The system also includes an organizational content management subsystem to provide an access of multiple organizational content to each of the multiple stakeholders based on the corresponding stakeholder workflow access. The system also includes an organizational activity analysis subsystem to track multiple activities performed by each of the multiple stakeholders corresponding to multiple tasks allocated and prioritized for each of the multiple stakeholders based on the corresponding multiple organizational contents accessed. The organizational activity analysis subsystem also analyzes the multiple activities tracked to provide one or more insights related to development of the organization using a learning technique. The system also includes an organizational process collaboration subsystem to provide one or more organization related services to each of the multiple stakeholders based on an integration of an existing external platform using an application programming interface.

In accordance with another embodiment of the present disclosure, a method for providing an integrated digital ecosystem for organization management is disclosed. The method includes establishing an integrated communication network for managing multiple stakeholders of an organization. The method also includes providing a stakeholder workflow access corresponding a level of permission for each of the multiple stakeholders based on the integrated communication network established. The method also includes providing an access of multiple organizational contents to each of the multiple stakeholders based on the corresponding stakeholder workflow access. The method also includes tracking multiple activities performed by each of the multiple stakeholders corresponding to multiple tasks allocated and prioritized for each of the multiple stakeholders based on the corresponding multiple organizational contents accessed. The method also includes analyzing the multiple activities tracked to provide one or more insights related to development of organization using a learning technique. The method also includes providing one or more organization related services to each of the multiple stakeholders based on integration of an existing external platform using an application programming interface.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram of a system of providing an integrated digital ecosystem for organization management in accordance with an embodiment of the present disclosure;

FIG. 2 is a block diagram of an exemplary system of providing an integrated digital ecosystem for organization management in accordance with an embodiment of the present disclosure;

FIG. 3 illustrates a block diagram of a computer or a server of FIG. 1 in accordance with an embodiment of the present disclosure; and

FIG. 4 is a flow chart representing the steps involved in a method of providing an integrated digital ecosystem for organization management of FIG. 1 in accordance with the embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a system and a method of providing an integrated digital ecosystem for organization management. The system includes one or more processors hosted on a server. The system also includes an organizational network management subsystem to establish an integrated communication network for managing multiple stakeholders of an organization. The organizational network management subsystem also provides a stakeholder workflow access corresponding to a level of permission for each of the multiple stakeholders based on the integrated communication network established. The system also includes an organizational content management subsystem to provide an access of multiple organizational contents to each of the multiple stakeholders based on the corresponding stakeholder workflow access. The system also includes an organizational activity analysis subsystem to track multiple activities performed by each of the multiple stakeholders corresponding to multiple tasks allocated and prioritized for each of the multiple stakeholders based on the corresponding multiple organizational contents accessed. The organizational activity analysis subsystem also analyzes the multiple activities tracked to provide one or more insights related to development of the organization using a learning technique. The system also includes an organizational process collaboration subsystem to provide one or more organization related services to each of the multiple stakeholders based on an integration of an existing external platform using an application programming interface.

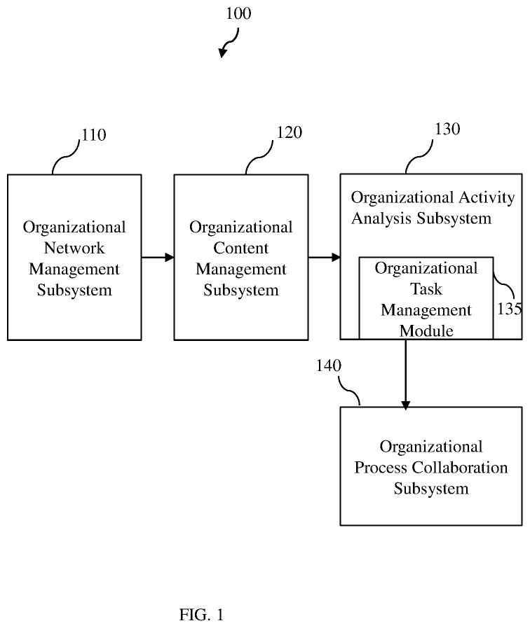

FIG. 1 is a block diagram of a system (100) of providing an integrated digital ecosystem for organization management in accordance with an embodiment of the present disclosure. The system (100) includes one or more processors hosted on a server. In one embodiment, the server may include a cloud server. In one embodiment, the system (100) includes a registration subsystem to register multiple stakeholders of an organization in the integrated digital ecosystem. In one embodiment, the multiple stakeholders may include multiple external stakeholders and an internal stakeholder. In such embodiment, the multiple external stakeholders may include at least one of a customer, a distributor, a vendor, a prospect or a combination thereof. In another embodiment, the internal stakeholder may include an employee of the organization. The system (100) also includes an organizational network management subsystem (110) to establish an integrated communication network for managing the multiple stakeholders of the organization. In one embodiment, the integrated communication network may include a global cloud network of the organization and people for working cohesively with each other. The organizational network management subsystem (110) also provides a stakeholder workflow access corresponding to a level of permission for each of the multiple stakeholders based on the integrated communication network established. As used herein, the term ‘level of permission’ is defined as a respective right to access information, people, system tools of the organization based on a type of the stakeholder.

The organizational network management subsystem (110) enables the customer to connect with the organization, provides the stakeholder workflow access corresponding to the level of the permission of the customer and assigns a dedicated account manager for communication. The organizational network management subsystem (110) also enables the distributor or a reseller or a partner to join the integrated digital ecosystem by sending an invitation, provides the stakeholder access corresponding to the level of permission of the distributor and allocates a dedicated partner manager and one or more other resources to provide assistance. The organizational network management subsystem (110) also enables the vendor such as multiple original equipment manufacturers (OEM)s to digitally connect with the organization. The organizational network management subsystem (110) also provides the stakeholder workflow access corresponding to the level of permission of the vendor and enables an exchange of information through the single integrated platform.

The organizational network management subsystem (110) also enables participation of the employee of the organization and provides corresponding level of stakeholder workflow access for integrated team management. In one embodiment, the organizational network management subsystem (110) also enables the employee to share one or more ideas or views within the organization or one or more public contacts associated with the integrated digital ecosystem. The organizational network management subsystem (110) also provides an automated social event management solution for sending a notification about the employee's birthday or anniversary to other employees within the organization. In one embodiment, the automated social event management solution may also connect with the organization approved gift vendors in advance for an arrangement of a gift for the employee. The organizational network management subsystem (110) also provides the stakeholder workflow access corresponding to the level of permission of the prospect or a free user. In one embodiment, the prospect may be provided but not limited to, an access to utilize a social media platform, an access of a storage platform, an access to network of companies, an access to communication and the like. In a specific embodiment, the organizational network management subsystem (110) also enables automatic synchronization of contacts between the multiple stakeholders and recognizes the contacts of the integrated digital ecosystem. Also, based on the stakeholder workflow access, the organizational network management subsystem (110) enables Public social updates automatically with them and manages both organization and personal connections with clear demarcation of both based on access rights and work flow.

The system (100) also includes an organizational content management subsystem (120) to provide an access of multiple organizational content to each of the multiple stakeholders based on the corresponding stakeholder workflow access. In one embodiment, the multiple organizational content may include at least one of an employee information, a department information, a client information, an organizational transaction information, a certification program information, a product information, a service information or a combination thereof. In such embodiment, the customer may access the product information or the service information based on a predefined requirement. In another embodiment, the distributor may access the certification programs information and the department information. In yet another embodiment, vendor may access the product information, the service information, the certification programs information, organizational transaction information and the like. In one embodiment, the employee may access the department information, the client information, the organizational transaction information and the like.

The system includes an organizational activity analysis subsystem (130). In a specific embodiment, the organizational activity analysis subsystem (130) also includes an organizational task management module (135) to allocate and prioritize multiple tasks for each of the multiple stakeholders upon the multiple organizational contents accessed by the multiple stakeholders. The organizational activity analysis subsystem (130) also tracks multiple activities performed by each of the multiple stakeholders corresponding to the multiple tasks allocated and prioritized for each of the multiple stakeholders. In one embodiment, the multiple activities may include at least one of a number of chats or calls completed by the employee, a number of the multiple organizational contents viewed by the reseller, distributor, the employee, the vendor, partner, the customer, a number of one or more certification programs completed by the vendor or the distributor or the customer, a number of training programs conducted by the organization with the customer or vice versa, a number of meetings conducted by the employee with the customer or a combination thereof. In one embodiment, the training programs may include internal training programs conducted for one or more newly joined employees or one or more existing employees of the organization.

The organizational activity analysis subsystem (130) also analyzes the multiple activities tracked to provide one or more insights related to development of the organization using a learning technique. In one embodiment, the multiple activities may be tracked to provide the one or more insights for better analysis and decision making related to the development of the organization. In such embodiment, the one or more insights may be predicted based on the analysis of the multiple activities using an artificial intelligence technique. In such embodiment, the artificial intelligence technique may include a supervised learning technique which may include one or more prediction models, but not limited to, a logistic regression model, a linear regression model, an artificial neural network model, a support vector machine (SVM) model and the like.

The system (100) also includes an organizational process collaboration subsystem (140) to provide one or more organization related services to each of the multiple stakeholders based on an integration of an existing external platform using an application programming interface. As used herein, the term ‘existing external platform’ is defined as one or more third-party collaboration platforms providing one or more business process applications. Similarly, the term ‘application programming interface (API)’ used herein, is defined as a publicly available application programming interface that provides developers with programmatic access to a proprietary software application for integration with another platform. In one embodiment, the one or more organization related services may include at least one of a human resource management (HRM) service, an enterprise resources planning (ERP) service, a customer relationship management (CRM) service, a conference management service, a webinar management service, an event organising service or a combination thereof.

In a particular embodiment, the system (100) further includes a support management subsystem to generate one or more tickets for resolution of one or more issues associated with each of the multiple stakeholders. In one embodiment, the support management subsystem also assigns a dedicated support executive to provide support for resolution of the one or more issues associated with each of the multiple stakeholders based on the one or more tickets generated. In such embodiment, the dedicated support executive or a dedicated account manager may provide updated information and solves the one or more queries or issues associated with the customer via a voice message, a chat, an audio call, a video call, a digital chatbot and the like.

In one embodiment, the support management subsystem may also send an annual maintenance contract (AMC) reminder, notification of latest product launches, notification of reviews of latest products and the like. In another embodiment, the support management subsystem (150) also provides support to the distributor corresponding to the latest product or the organization by the dedicated partner manager or the dedicated support executive. In such embodiment, the support may be provided via the audio call, the video call, the chat and the like.

In one embodiment, the support management subsystem (150) may provide support to the vendor through the dedicated support executive of a purchase department or other relevant departments of the organization. In such embodiment, the support management subsystem (150) may also receive support from the vendor related to one or more products purchased from the vendor. In another embodiment, the support management subsystem (150) also provides support to the prospect or a free user by communicating via the audio call, the video call, the chat and the like.

In a specific embodiment, the system (100) further includes a license management subsystem to manage multiple types of licenses of the organization for collaborating each of the multiple stakeholders. In one embodiment, the multiple licenses may include, but not limited to, an employee license, a customer license, a distributor or a reseller license, a vendor license and the like. In such embodiment, the license policies and license fee may vary based on the multiple types of the licenses.

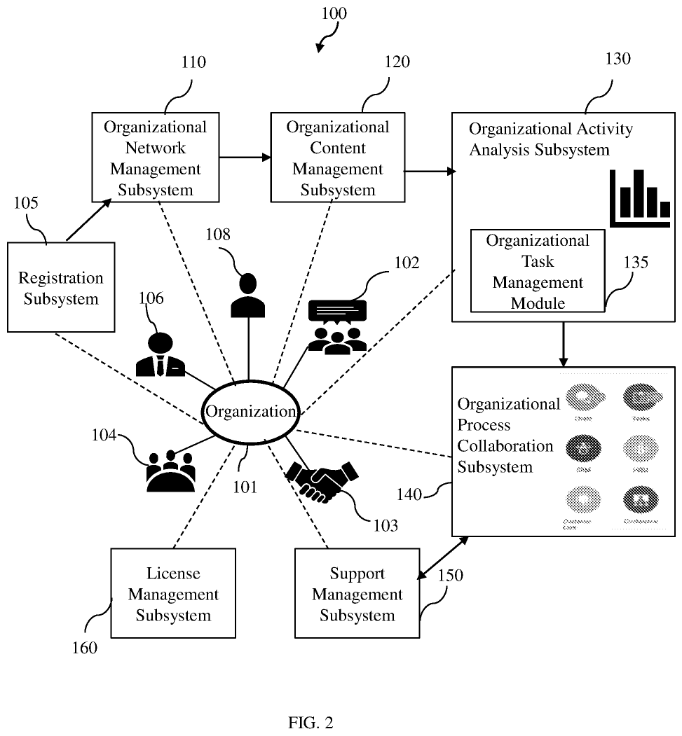

FIG. 2 is a block diagram of an exemplary embodiment of a system (100) of providing an integrated digital ecosystem for organization management in accordance with an embodiment of the present disclosure. The system (100) is useful to digitally transform an organization (101) completely for a daily-basis transaction process. The system (100) is sector-agnostic and helps in digital transformation of the organization to achieve one or more business objectives. Considering an example, wherein an organization ‘X’ (101) is a software-product based organization. In such a large organization (101), there are several stakeholders but all such stakeholders are not tied up together in a single integrated platform. As a result, the organization (101) is still partially digitized. In order to achieve complete digital transformation of the organization ‘X’, multiple stakeholders of the organization (101) need to be combined at the single integrated platform for interconnection among themselves. The system (100) helps in the complete digitization of the organization (101) by providing an integrated digital ecosystem which requires a registration of the multiple stakeholders. The system (100) includes a registration subsystem (105) which registers the multiple stakeholders of the organization in the integrated digital ecosystem. In the example used herein, the multiple stakeholders may include a customer (102) such as an enterprise ‘Y’, a partner (103) or a reseller or a distributor, a vendor (104), one or more employees (106) of the organization, prospect (108) and the like.

Once the multiple stakeholders are registered, an integrated communication network established by an organizational network management subsystem (110) enables managing the multiple stakeholders of the organization (101). For example, the integrated communication network may include a global cloud network of the organization (101) and the multiple stakeholders for providing a cohesive working environment. The organizational network management subsystem (110) also provides a stakeholder workflow access corresponding to a level of permission for each of the multiple stakeholders based on the integrated communication network established. For example, the stakeholder workflow access provided to the customer enables the customer (102) to login as a company and get access to connect with the organization ‘X’ via a dedicated account manager. The dedicated account manager provides information including but not limited to, one or more products already developed by the organization, one or more products which are in development phase, information about latest one or more product launches and the like.

Similarly, the stakeholder workflow access provided to the reseller or the distributor or the partner (103) enables the reseller to access organizational content related to one or more tasks which are assigned for completion. The organizational network management subsystem (110) allocates a dedicated partner manager to provide relevant updates corresponding to the organizational content required by the reseller or the distributor. Also, in the example used herein, the organizational network management subsystem (110) provides the stakeholder workflow access to the vendor (104) based on the level of permission associated with the vendor (104). For example, the vendor (104) may be provided the stakeholder workflow access related to purchasing information of the organization (101), accounts department of the organization and the like. Again, the employee (106) of the organization (101) who is an internal stakeholder, the stakeholder workflow access may be provided to connect with other employees of multiple departments of the organization (101). In addition, the organizational network management subsystem (110) may provide the stakeholder workflow access to the free user (108) for accessing the integrated platform the organization (101) as a social media platform, a storage platform, a communication platform for accessing network of companies and the like.

Further, an organizational content management subsystem (120) provides an access of multiple organizational content to each of the multiple stakeholders based on the corresponding stakeholder workflow access. In the example used herein, the multiple organizational content may include at least one of an employee information, a department information, a client information, an organizational transaction information, a certification programs information, a product information, a service information or a combination thereof. For example, the customer (102) may access the product information which includes information about stages of the product developed, maintenance information related to the product and the like. Similarly, the distributor (103) may access the certification programs information available in the organization and the department information of the organization. Again, the vendor (104) may access the product requirement information, the certification programs information, organizational transaction information, the purchasing department information and the like. Also, the employee (106) may access the organizational content such as product development information, one or more notices, memos, product development requirements of clients and the like.

Upon accessing the multiple organizational contents by each of the multiple stakeholders, an organizational task management module (135) allocates and prioritize multiple tasks for each of the multiple stakeholders. For example, the multiple tasks are assigned either by multiple external stakeholders such as the customer, the reseller and the vendor. The employee (106) which is the internal stakeholder needs to complete the multiple tasks which are allocated and prioritized for completion. An organizational activity analysis subsystem (130) tracks multiple activities performed by each of the multiple stakeholders corresponding to the multiple tasks allocated and prioritized for each of the multiple stakeholders. For example, the multiple activities may include at least one of a number of chats or calls completed by the employee, a number of the multiple organizational contents such as videos, documents, tutorials viewed by the reseller, distributor, the employee, the vendor, partner, the customer, a number of one or more certification programs completed by the vendor or the distributor or the customer, a number of training programs conducted by the organization with the customer or vice versa, a number of meetings conducted by the employee with the customer or a combination thereof. In the example used herein, the training programs may include internal training programs conducted for one or more newly joined employees or one or more existing employees of the organization.

Based on the tracking of the multiple activities, the organizational activity analysis subsystem (130) provides one or more insights related to development of the organization using a learning technique. For example, the multiple activities may be tracked to provide the one or more insights for better analysis and decision making related to the development of the organization. In the example used herein, the one or more insights may be predicted using an artificial intelligence technique.

Moreover, the system (100) also includes an organizational process collaboration subsystem (140) which provides one or more organization related services to each of the multiple stakeholders based on an integration of an existing external platform using an application programming interface (API). Here, the one or more organization related services may include at least one of a human resource management (HRM) service, an enterprise resources planning (ERP) service, a customer relationship management (CRM) service, a conference management service, a webinar management service, an event organizing service or a combination thereof.

Furthermore, the system (100) also includes a support management subsystem (150) to generate one or more tickets for resolution of one or more issues associated with each of the multiple stakeholders. The support management subsystem (150) also assigns a dedicated support executive to provide support for resolution of the one or more issues associated with each of the multiple stakeholders based on the one or more tickets generated. For example, the dedicated support executive or a dedicated account manager may provide updated information and solves the one or more queries or issues associated with the customer via a voice message, a chat, an audio call, a video call, a digital chatbot and the like.

Similarly, the support management subsystem (150) may also send an annual maintenance contract (AMC) reminder associated with the product, notification of latest product launches, notification of reviews of latest products and the like to the customer. Again, the support management subsystem (150) also provides support to the distributor corresponding to the latest product or the organization by the dedicated partner manager or the dedicated support executive. Here, the support may be provided via the audio call, the video call, the chat and the like. In addition to the system (100) includes a license management subsystem (160) to manage with multiple types of licenses of the organization for collaborating each of the multiple stakeholders. In the example used herein, the multiple licenses may include, but not limited to, an employee license, a customer license, a distributor or a reseller license, a vendor license and the like. The license policies and license fee may vary based on the multiple types of licenses. The multiple types of license policies help each of the organizations to maintain a healthy relationship with each of the multiple stakeholders present within the integrated digital ecosystem.

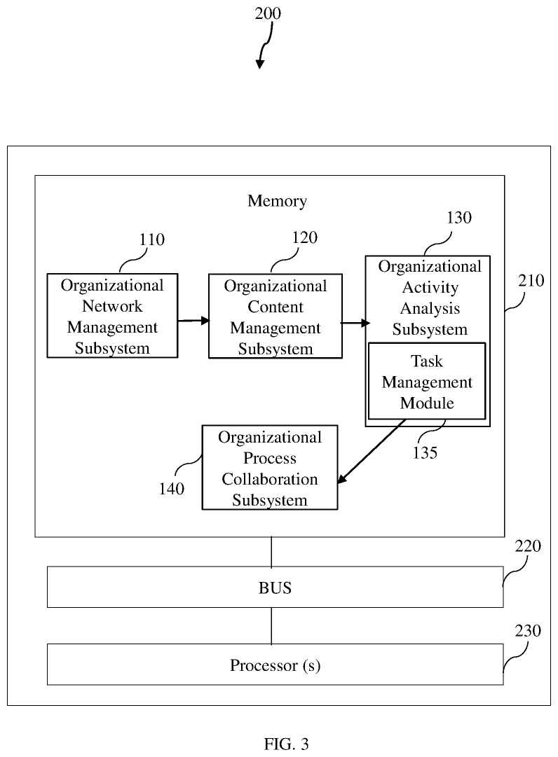

FIG. 3 illustrates a block diagram of a computer or a server of FIG. 1 in accordance with an embodiment of the present disclosure. The server (200) includes processor(s) (230), and memory (210) operatively coupled to the bus (220). The processor(s) (230), as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The memory (210) includes several subsystems stored in the form of executable program which instructs the processor (230) to perform the method steps illustrated in FIG. 1. The memory (210) is substantially similar to a system (100) of FIG. 1. The memory (210) has following subsystem: an organizational network management subsystem (110), an organizational content management subsystem (120), an organizational activity analysis subsystem (130) and an organizational process collaboration subsystem (140).

The organizational network management subsystem (110) establishes an integrated communication network for managing multiple stakeholders of an organization. The organizational network management subsystem (110) also provides a stakeholder workflow access corresponding to a level of permission for each of the multiple stakeholders based on the integrated communication network established. The organizational content management subsystem (120) provides an access of multiple organizational contents to each of the multiple stakeholders based on the corresponding stakeholder workflow access. The organizational activity analysis subsystem (130) tracks multiple activities performed by each of the multiple stakeholders corresponding to multiple tasks allocated and prioritized for each of the multiple stakeholders based on the corresponding multiple organizational contents accessed. The organizational activity analysis subsystem (130) also analyzes the multiple activities tracked to provide one or more insights related to development of the organization using a learning technique. The organizational process collaboration subsystem (140) provides one or more organization related services to each of the multiple stakeholders based on an integration of an existing external platform using an application programming interface.

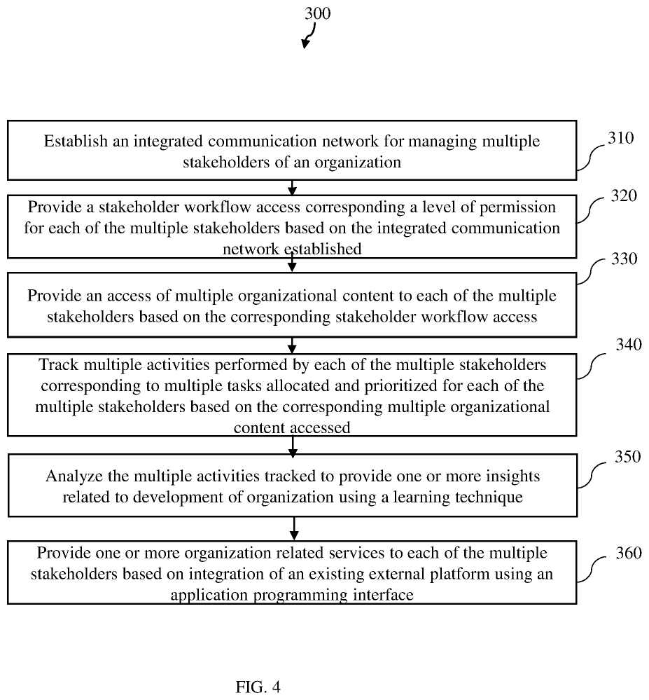

FIG. 4 is a flow chart representing the steps involved in a method (300) of providing an integrated digital ecosystem for organization management of FIG. 1 in accordance with the embodiment of the present disclosure. The method (300) includes establishing an integrated communication network for managing multiple stakeholders of an organization in step 310. In one embodiment, establishing the integrated communication network for managing the multiple stakeholders may include establishing the integrated communication network for managing at least one of a customer, a distributor, a vendor, a prospect or a combination thereof.

The method (300) also includes providing a stakeholder workflow access corresponding a level of permission for each of the multiple stakeholders based on the integrated communication network established in step 320. In one embodiment, providing the stakeholder workflow access corresponding to the level of permission for each of the multiple stakeholders may include providing the stakeholder workflow access as a respective right to access information, people or system tools of the organization based on a type of the each of the multiple stakeholders.

The method (300) also includes providing an access of multiple organizational contents to each of the multiple stakeholders based on the corresponding stakeholder workflow access in step 330. In an embodiment, providing the access of multiple organizational contents to each of the multiple organizational contents may include providing the access of at least one of an employee information, a department information, a client information, an organizational transaction information, a certification programs information, a product information, a service information or a combination thereof. In such embodiment, the customer may access the product information or the service information based on a predefined requirement. In another embodiment, the distributor may access the certification programs information and the department information. In yet another embodiment, vendor may access the product information, the service information, the certification programs information, organizational transaction information and the like. In one embodiment, the employee may access the department information, the client information, the organizational transaction information and the like.

The method (300) also includes tracking multiple activities performed by each of the multiple stakeholders corresponding to multiple tasks allocated and prioritized for each of the multiple stakeholders based on the corresponding multiple organizational contents accessed in step 340. The method (300) also includes analyzing the multiple activities tracked to provide one or more insights related to development of organization using a learning technique in step 350. In one embodiment, analyzing the multiple activities tracked to provide the one or more insights related to the development of the organization may include analyzing the multiple activities which may include, but not limited to, a number of chats or calls completed by the employee, a number of the multiple organizational contents viewed by the reseller, distributor, the employee, the vendor, partner, the customer, a number of one or more certification programs completed by the vendor or the distributor or the customer, a number of training programs conducted by the organization with the customer or vice versa, a number of meetings conducted by the employee with the customer or a combination thereof. In one embodiment, the training programs may include internal training programs conducted for one or more newly joined employees or one or more existing employees of the organization.

The method (300) also includes providing one or more organization related services to each of the multiple stakeholders based on integration of an existing external platform using an application programming interface in step 360. In one embodiment, providing the one or more organization related services to each of the multiple stakeholders may include providing the one or more organization related services which may include at least one of a human resource management (HRM) service, an enterprise resources planning (ERP) service, a customer relationship management (CRM) service, a conference management service, a webinar management service, an event organising service or a combination thereof.

In a specific embodiment, the method (300) further includes generating one or more tickets for resolution of one or more issues associated with each of the multiple stakeholders. In one embodiment, the method (300) further includes assigning a dedicated support executive to provide support for resolution of the one or more issues associated with each of the multiple stakeholders based on the one or more tickets generated. In such embodiment, the dedicated support executive or a dedicated account manager may provide updated information and solves the one or more queries or issues associated with the customer via a voice message, a chat, an audio call, a video call, a digital chatbot and the like.

Various embodiments of the present disclosure provides the integrated digital ecosystem for the organization which is centralized and stored on a cloud server and as a result, all the data related to the multiple stakeholders associated with the organization are stored in the cloud server. The organization does not need to locally store the data related to the multiple stakeholders on a local server which in turn is reducing the storage load, dependency and processing load of the local server. Also, the organization in order to achieve the complete digitization is able to access the data remotely from the cloud server without connecting several local servers. Moreover, such an integrated system also reduces the need of the organization to maintain data related to one or more external service providing platforms locally, thus reduces the load on the local server.

Various embodiments of the present disclosure enable each of the multiple stakeholders of the organization to obtain every expectation from the organization and also in turn enable the organization to achieve its goals with the help of the complete digitization of the organization.

Moreover, the present disclosed system involves data analytics at each level which indicates the productivity outcomes and efficiency of each of the multiple stakeholders in the digital ecosystem.

Furthermore, the present disclosed system also offers a single platform for the free users or the prospects where they get access to social networks for chat, audio call or video call, cloud drive for storage and easy sharing with contacts and task management. Also, the present disclosed system offers an access to the network of organizations where they can follow or connect based on their preferences and as a result benefits both the free users as well as the organizations.

In addition, the present disclosed system also provides the one or more external services based on an integration with third-party platforms to ensure that the one or more external services for collaboration of each of the multiple stakeholders are provided from a single interface and as a result avoids wastage of time and effort of each of the multiple stakeholders.

It will be understood by those skilled in the art that the foregoing general description and the following detailed description are exemplary and explanatory of the disclosure and are not intended to be restrictive thereof.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A system (100) of providing an integrated digital ecosystem for organization management, the system comprising:
one or more processors (230) hosted on a server;
an organizational network management subsystem (110) operatively coupled to the one or more processors (230), wherein the organizational network management subsystem (110) is configured to:
establish an integrated communication network for managing a plurality of stakeholders of an organization; and
provide a stakeholder workflow access corresponding to a level of permission for each of the plurality of stakeholders based on the integrated communication network established;
an organizational content management subsystem (120) operatively coupled to the one or more processors (230), wherein the organizational content management subsystem (120) is configured to provide an access of a plurality of organizational content to each of the plurality of stakeholders based on the corresponding stakeholder workflow access;
an organizational activity analysis subsystem (130) operatively coupled to the one or more processors (230), wherein the organizational activity analysis subsystem (130) is configured to:
track a plurality of activities performed by each of the plurality of stakeholders corresponding to a plurality of tasks allocated and prioritized for each of the plurality of stakeholders based on the corresponding plurality of organizational content accessed; and
analyze the plurality of activities tracked to provide one or more insights related to development of the organization using a learning technique; and
an organizational process collaboration subsystem (140) operatively coupled to the one or more processors (230), wherein the organizational process collaboration subsystem (140) is configured to provide one or more organization related services to each of the plurality of stakeholders based on an integration of an existing external platform using an application programming interface.

2. The system (100) as claimed in claim 1, comprising a registration subsystem (105) operatively coupled to the one or more processors, wherein the registration subsystem is configured to register the plurality of stakeholders of the organization in the integrated digital ecosystem.

3. The system (100) as claimed in claim 1, wherein the plurality of stakeholders comprises at least one of a customer, a distributor, a vendor, a prospect, an employee or a combination thereof.

4. The system (100) as claimed in claim 1, wherein the plurality of organizational content comprises at least one of an employee information, a department information, a client information, an organizational transaction information, a certification programs information, a product information, a service information or a combination thereof.

5. The system (100) as claimed in claim 1, wherein the organizational activity analysis subsystem (130) also includes an organizational task management module (135) to allocate and prioritize the plurality tasks for each of the plurality of stakeholders upon the plurality of organizational content accessed by the plurality of stakeholders.

6. The system (100) as claimed in claim 1, wherein the plurality of activities comprises at least one of a number of chats or calls completed by the corresponding plurality of stakeholders, a number of the plurality of organizational contents viewed by the corresponding plurality of stakeholders, a number of one or more certification programs completed by the corresponding plurality of stakeholders, a number of training programs conducted by the corresponding plurality of stakeholders, a number of meetings conducted by the corresponding plurality of stakeholders or a combination thereof.

7. The system (100) as claimed in claim 1, wherein the one or more organization related services comprises at least one of a human resource management service, an enterprise resources planning service, a customer relationship management service, a conference management service, a webinar management service, an event organizing service or a combination thereof.

8. The system (100) as claimed in claim 1, comprising a support management subsystem (150) operatively coupled to the one or more processors, wherein the support management subsystem is configured to generate one or more tickets for resolution of one or more issues associated with each of the plurality of stakeholders.

9. The system (100) as claimed in claimed in claim 8, wherein the support management subsystem (150) is configured to assign a dedicated support executive to provide support for resolution of the one or more issues associated with each of the plurality of stakeholders based on the one or more tickets generated.

10. A method (300) for providing an integrated digital ecosystem for organization management, the method comprising:
establishing, by an organizational network management subsystem, an integrated communication network for managing a plurality of stakeholders of an organization (310);
providing, by the organizational network management subsystem, a stakeholder workflow access corresponding a level of permission for each of the plurality of stakeholders based on the integrated communication network established (320);
providing, by an organizational content management subsystem, an access of a plurality of organizational content to each of the plurality of stakeholders based on the corresponding stakeholder workflow access (330);
tracking, by an organizational activity analysis subsystem, a plurality of activities performed by each of the plurality of stakeholders corresponding to a plurality of tasks allocated and prioritized for each of the plurality of stakeholders based on the corresponding plurality of organizational content accessed (340);
analyzing, by the organizational activity analysis subsystem, the plurality of activities tracked to provide one or more insights related to development of organization using a learning technique (350); and
providing, by an organizational process collaboration subsystem, one or more organization related services to each of the plurality of stakeholders based on integration of an existing external platform using an application programming interface (360).
